(19) United States
(12) Patent Application Publication
(10) Pub. No.: US 2025/0233277 A1
(43) Pub. Date: Jul. 17, 2025

(54) LEAPING BUS BAR

(71) Applicant: Caterpillar Inc., Peoria, IL (US)

(72) Inventors: Trent MURRAY, Morton, IL (US); Matthew Ryan SWANK, Washington, IL (US); Jared J. BRODBECK, Metamora, IL (US); Elizabeth A. JONES, Mackinaw, IL (US)

(73) Assignee: Caterpillar Inc., Peoria, IL (US)

(21) Appl. No.: 18/411,552

(22) Filed: Jan. 12, 2024

(51) Int. Cl. H01M 50/507; H01M 50/204; H01M 50/51

(52) U.S. Cl. CPC H01M 50/507; H01M 50/51; H01M 50/204

(57) ABSTRACT

In some implementations, a battery module may include a battery stack with a plurality of battery cells, a leaping bus bar electrically connecting multiple non-adjacent battery cells of the plurality of battery cells, and a linear bus bar electrically connecting multiple adjacent battery cells of the plurality of battery cells. The multiple adjacent battery cells may be disposed between the multiple non-adjacent battery cells electrically connected by the leaping bus bar.

### TECHNICAL FIELD

The present disclosure relates generally to batteries and, for example, to a leaping bus bar for electrically connecting battery cells and/or battery modules.

### BACKGROUND

Bus bars are electrical conductors that electrically connect battery cells and battery modules in a battery pack. The shape and arrangement of the bus bars can be used to connect battery terminals in series or parallel. Moreover, a typical bus bar configuration in a prismatic cell layout results in the terminals of the battery module being located on opposite ends of the battery module, which can make it difficult to service the battery pack, particularly in applications where the battery pack is heavy and where one or both of the opposite ends of the battery pack are inaccessible.

U.S. Pat. No. 11,677,114 (the '114 patent) discloses a plurality of batteries stacked together, and a bus bar that electrically connects the plurality of batteries with each other. The bus bar has a main body that extends along an axis along which the batteries are stacked together, and a plurality of connectors, that protrude from the main body along an axis that intersects with the axis along which the batteries are stacked together, that are electrically connected with terminals of the batteries, respectively. The plurality of batteries are divided into a plurality of battery units. Each of the plurality of battery units includes at least two of the plurality of batteries. The bus bar connects the at least two of the plurality of batteries of each of the battery units with each other in parallel. The bus bar connects the battery units with each other in series.

The bus bars disclosed in the '114 patent place the terminals of the battery module on opposite sides of the battery module, which as discussed above, makes the battery pack difficult to install and service, particularly when the battery pack is used in a situation where one or both of the opposite ends are not easily accessible.

The leaping bus bar of the present disclosure solves one or more of the problems set forth above and/or other problems in the art.

### SUMMARY

A battery module may include a battery stack with a plurality of battery cells; a leaping bus bar electrically connecting multiple non-adjacent battery cells of the plurality of battery cells; and a linear bus bar electrically connecting multiple adjacent battery cells of the plurality of battery cells, the multiple adjacent battery cells being disposed between the multiple non-adjacent battery cells electrically connected by the leaping bus bar.

A machine may include an electric motor; and a battery module electrically connected to the electric motor, the battery module including: a battery stack with a plurality of battery cells, a leaping bus bar electrically connecting multiple non-adjacent battery cells of the battery stack, and a linear bus bar electrically connecting multiple adjacent battery cells of the battery stack, the multiple adjacent battery cells being disposed between the multiple non-adjacent battery cells electrically connected by the leaping bus bar, and the linear bus bar being nested within a cutout edge of the leaping bus bar.

A battery pack may include a first battery module; and a second battery module electrically connected to the first battery module, both the first battery module and the second battery module having terminals on a same end of the battery pack, and the first battery module and the second battery module each including: a battery stack with a plurality of battery cells, a leaping bus bar electrically connecting multiple non-adjacent battery cells of the plurality of battery cells, and a linear bus bar electrically connecting multiple adjacent battery cells of the plurality of battery cells, the multiple adjacent battery cells being disposed between the multiple non-adjacent battery cells electrically connected by the leaping bus bar.

### BRIEF DESCRIPTION OF THE DRAWINGS

FIG. 1 is a diagram of an example battery pack.

FIG. 2 is an isometric view of an example battery module with leaping bus bars and linear bus bars.

FIG. 3 is a top view of an example battery module.

### DETAILED DESCRIPTION

This disclosure relates to a leaping bus bar, which is applicable to any battery module and/or battery pack that provides power to a machine. For example, the machine may perform an operation associated with an industry, such as mining, construction, farming, transportation, or any other industry. For example, the machine may be an electric vehicle, an electric work machine (e.g., a compactor machine, a paving machine, a cold planer, a grading machine, a backhoe loader, a wheel loader, a harvester, an excavator, a motor grader, a skid steer loader, a tractor, and/or a dozer), or an energy storage system, among other examples. As used herein, “battery cell,” “battery,” and “cell” may be used interchangeably.

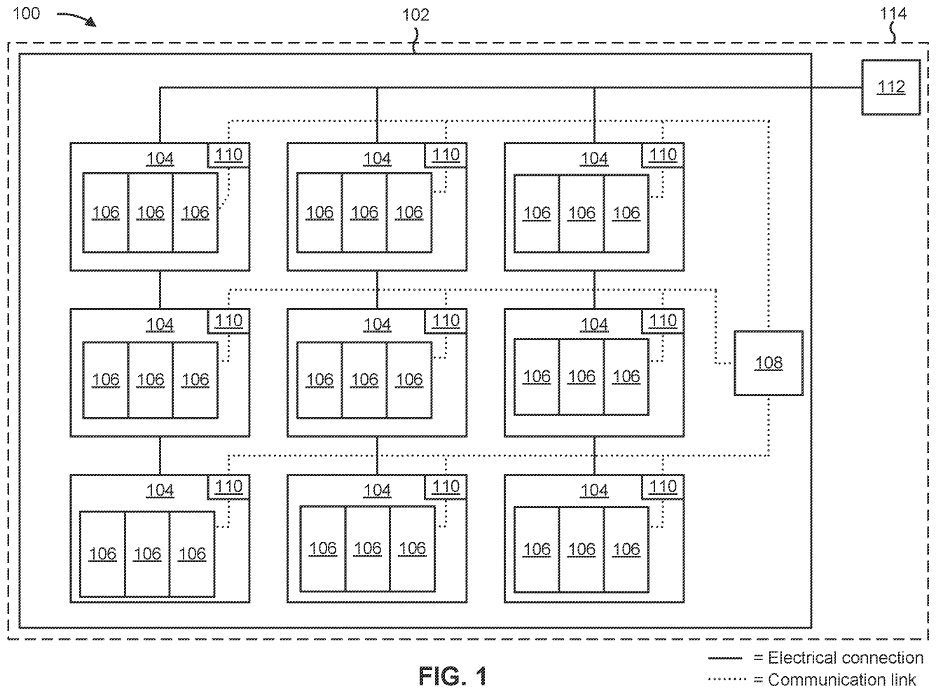

FIG. 1 is a diagram of an example battery pack 100. The battery pack 100 may include a battery pack housing 102, one or more battery modules 104, and one or more battery cells 106. The battery pack 100 includes a battery pack controller 108 associated with storing information and/or controlling one or more operations associated with the battery pack 100. Each battery module 104 includes a module controller 110 associated with storing information and/or controlling one or more operations associated with the battery module 104.

The battery pack 100 may be associated with a component 112. The component 112 may be powered by the battery pack 100. For example, the component 112 can be a load that consumes energy provided by the battery pack 100, such as an electric motor, among other examples. As another example, the component 112 provides energy to the battery pack 100 (e.g., to be stored by the battery cells 106). In such examples, the component 112 may be a power generator, a solar energy system, and/or a wind energy system, among other examples. A machine 114 may include the battery pack 100 and the component 112 (e.g., an electric motor). For example, the battery pack 100 (e.g., one or more battery modules 104 thereof) may be electrically connected to the component 112. The machine 114 may be an electric vehicle (e.g., a car, a train, or a boat) or an electric work machine.

The battery pack housing 102 may include metal shielding (e.g., steel, aluminum, or the like) to protect elements (e.g., battery modules 104, battery cells 106, the battery pack controller 108, the module controllers 110, wires, circuit boards, or the like) positioned within battery pack housing 102. Each battery module 104 includes one or more (e.g., a plurality of) battery cells 106 (e.g., positioned within a housing of the battery module 104). Battery cells 106 may be connected in series and/or in parallel within the battery module 104 (e.g., via terminal-to-busbar welds). Each battery cell 106 is associated with a chemistry type. The chemistry type may include lithium ion (Li-ion), nickel-metal hydride (NiMH), nickel cadmium (NiCd), lithium ion polymer (Li-ion polymer), lithium iron phosphate (LFP), and/or nickel manganese cobalt (NMC), among other examples.

The battery modules 104 may be arranged within the battery pack 100 in one or more strings. For example, the battery modules 104 are connected via electrical connections, as shown in FIG. 1. The electrical connections may be removable, such as via bolts and/or nuts at one or more terminals on housings of the battery modules 104. The battery modules 104 may be connected in series and/or in parallel. For example, a number of battery modules 104 may be connected in series to provide a particular voltage (e.g., to the component 112). Alternatively, a number of battery modules 104 may be connected in parallel to increase a current and/or a power output of the battery pack 100. The number of battery cells 106 included in each battery module 104, and the number of battery modules 104 included in the battery pack 100 (e.g., and the relative serial and/or parallel connections of the battery cells 106 and/or the battery modules 104) may be associated with the required output power and an intended use of the battery pack 100. For example, any number of battery cells 106 can be included in a battery module 104. Similarly, any number of battery modules 104 can be included in the battery pack 100.

The battery pack controller 108 is communicatively connected (e.g., via a communication link) to each module controller 110. The battery pack controller 108 may be associated with receiving, generating, storing, processing, providing, and/or routing information associated with the battery pack 100. The battery pack controller 108 may also be referred to as a battery pack management device or system. The battery pack controller 108 may communicate with the component 112 and/or a controller of the component 112, may control a start-up and/or shut-down procedure of the battery pack 100, may monitor a current and/or voltage of a string (e.g., of battery modules 104), and/or may monitor and/or control a current and/or voltage provided by the battery pack 100, among other examples. A module controller 110 may be associated with receiving, generating, storing, processing, providing, and/or routing information associated with a battery module 104. The module controller 110 may communicate with the battery pack controller 108.

The battery pack controller 108 and/or a module controller 110 may be associated with monitoring and/or determining a state of charge (SOC), a state of health (SOH), a depth of discharge (DOD), an output voltage, a temperature, and/or an internal resistance and impedance, among other examples, associated with a battery module 104 and/or associated with the battery pack 100. Additionally, or alternatively, the battery pack controller 108 and/or the module controller 110 may be associated with monitoring, controlling, and/or reporting one or more parameters associated with battery cells 106. The one or more parameters may include cell voltages, temperatures, chemistry types, a cell energy throughput, a cell internal resistance, and/or a quantity of charge-discharge cycles of a battery module 104, among other examples.

As indicated above, FIG. 1 is provided as an example. Other examples may differ from what is described with regard to FIG. 1.

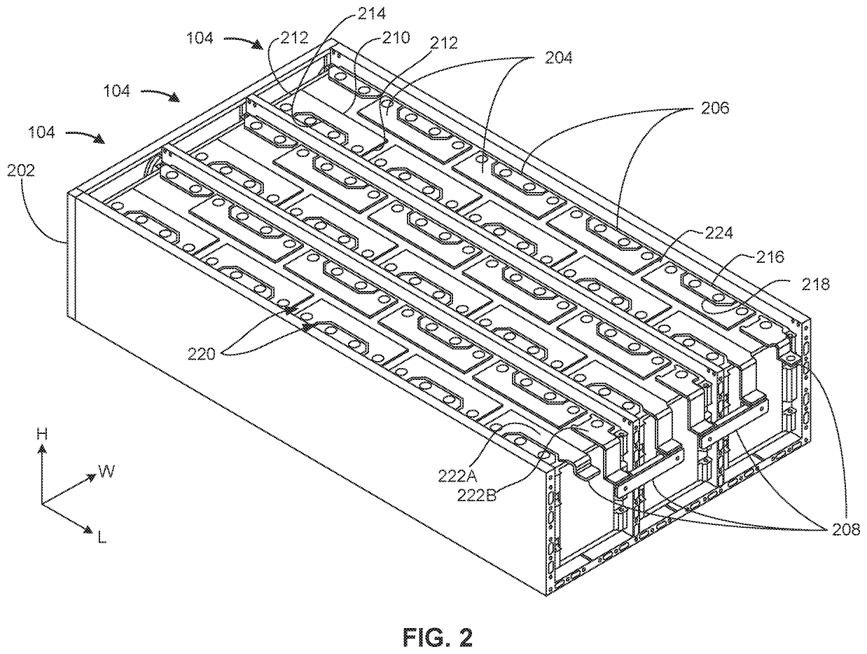

FIG. 2 is an isometric view of example battery modules 104, each with a module housing 202, leaping bus bars 204, linear bus bars 206, and module terminals 208. A battery module 104 may include a battery stack with a plurality of battery cells 106. For example, the battery stack may include an odd number of battery cells 106, such as 13 battery cells, 19 battery cells, or the like. In other examples, the battery stack may include an even number of battery cells 106.

The module housing 202 may house one or more of the battery cells 106 (e.g., may house the battery stack), discussed above with respect to FIG. 1. The module housing 202 may be formed from plastic, metal, or another rigid material. The module housing 202 may be used to generally protect the battery cells 106 from external forces and potential contaminants. In some scenarios, the module housing 202 may further help maintain the temperature of the battery cells 106 through, for example, heat dissipation.

The leaping bus bars 204 and linear bus bars 206 may be formed of strips or bars of a conductive material. The leaping bus bars 204 and linear bus bars 206 may serve as conduits for allowing electrical currents to flow between individual battery cells 106, groups of battery cells 106, and/or between battery modules 104. The leaping bus bars 204 and the linear bus bars 206 may have shapes, thicknesses, or other characteristics that help maintain consistent electrical properties (i.e., voltage and/or current) between components, as discussed in greater detail below. Each leaping bus bar 204 may electrically connect multiple (e.g., two) non-adjacent battery cells 106 in the battery module. For example, each leaping bus bar 204 electrically connects two battery cells 106, and two other battery cells 106 (that are not electrically connected to the leaping bus bar 204) are between the two battery cells 106 electrically connected by the leaping bus bar 204. Each linear bus bar 206 may electrically connect multiple (e.g., two) adjacent battery cells 106 in the battery module 104. For example, each linear bus bar 206 may electrically connect the battery cells 106 between battery cells 106 connected by a leaping bus bar 204.

The leaping bus bars 204 may have a unitary construction formed from, for example, a single plate. The plate of a leaping bus bar 204 may have a flat edge 210 perpendicular to two flat sides 212. The flat sides 212 may be parallel to one another on opposite ends of the flat edge 210. Opposite the flat edge 210 may be a cutout edge 214. The cutout edge 214 may be contoured with curved or flat edges. The shape of the cutout edge 214 may at least partially match a peripheral shape of a linear bus bar 206. In the example of FIG. 2, the cutout edge 214 has a U-shaped configuration, such that the leaping bus bar 204 has an overall U-shape.

The linear bus bars 206 may also have a unitary construction formed from a single plate, which may be the same or a different plate as the leaping bus bars 204. The linear bus bars 206 may each have a flat edge 216 opposite a contoured edge 218. The contoured edge 218 may match the contour of the cutout edge 214 of the leaping bus bars 204 to allow the linear bus bar 206 to nest within the cutout edge 214 of a leaping bus bar 204, thereby reducing an overall footprint of the bus bars on the battery module 104.

When assembled onto the battery cells 106, the flat edge 216 of each linear bus bar 206 may be parallel to a flat edge 210 of a corresponding leaping bus bar 204 such that the linear bus bar 206 is nested within the cutout edge 214 of the leaping bus bar 204 to form a bus bar set. Further, when assembled onto the battery cells 106, an air gap 220, which may electrically insulate the leaping bus bars 204 from the linear bus bars 206, may be defined between each of the linear bus bars 206 and the corresponding leaping bus bar 204 despite the matching contours of the contoured edge 218 and the cutout edge 214. Additional air gaps 220 may separate each of the leaping bus bars 204 from one another.

The leaping bus bars 204 and the linear bus bars 206 may have various characteristics that improve performance, such as maintaining accuracy of battery measurements despite, for example, a difference in voltage drop across the bus bars 204, 206. For example, despite being different lengths and having different shapes, a leaping bus bar 204 and a linear bus bar 206 may have the same (e.g., equal) electrical resistance if at least a portion of the leaping bus bar 204 and a portion of the linear bus bar 206 have the same cross-sectional area. For example, the leaping bus bar 204 and the linear bus bar 206 may have different thicknesses from each other to equalize their electrical resistances. The cross-sectional areas may be defined as a height H of the leaping bus bar 204 or linear bus bar 206 multiplied by a width W or length L of the leaping bus bar 204 or the linear bus bar 206, respectively, given a particular cross-section. The height H may be a distance the linear bus bar 206 and/or leaping bus bar 204 extends away from a top surface of the battery cell. The width W, which is perpendicular to the height H, may be a distance the linear bus bar 206 and/or the leaping bus bar 204 extends between terminals of the same battery cell. The length L may be perpendicular to both the width W and height H. Because the leaping bus bars 204 and linear bus bars 206 shown in FIG. 2 do not have uniform widths W across all cross-sections, the term “cross-sectional area” may refer to a greatest cross-sectional area, a smallest cross-sectional area, a median cross-sectional area, an average cross-sectional area, or a cross-sectional area taken at, for example, a center of the leaping bus bar 204 and/or the linear bus bar 206.

Further, for a battery module 104, the leaping bus bars 204 and linear bus bars 206 may be arranged on the same surface or plane as one another. For example, the leaping bus bars 204 and the linear bus bars 206 may be disposed on the same surface of a printed circuit board 224, which may be disposed on the battery module 104.

A battery module 104 may further include multiple terminal bus bars 222 (shown as terminal bus bars 222A and 222B), forming the module terminals 208, at one end of the battery module 104. The module terminals 208 may electrically connect multiple battery cells 106 in a battery stack to one another and/or electrically connect multiple battery stacks to one another in the battery module 104. Further, the module terminals 208 of multiple battery modules 104 may be electrically connected to one another to form the battery pack 100. The terminal bus bars 222 may have different shapes or configurations from one another, and/or from the leaping bus bars 204 and the linear bus bars 206, depending on a location of the terminal bus bar 222 relative to the edge of the battery module 104. For example, a first terminal bus bar 222A may be longer than a second terminal bus bar 222B, which may allow the first terminal bus bar 222A and the second terminal bus bar 222B to extend from the same end of the battery stack. A terminal 222 may be partially in the shape of a leaping bus bar 204 or a linear bus bar 206, described herein.

As indicated above, FIG. 2 is provided as an example. Other examples may differ from what is described with regard to FIG. 2.

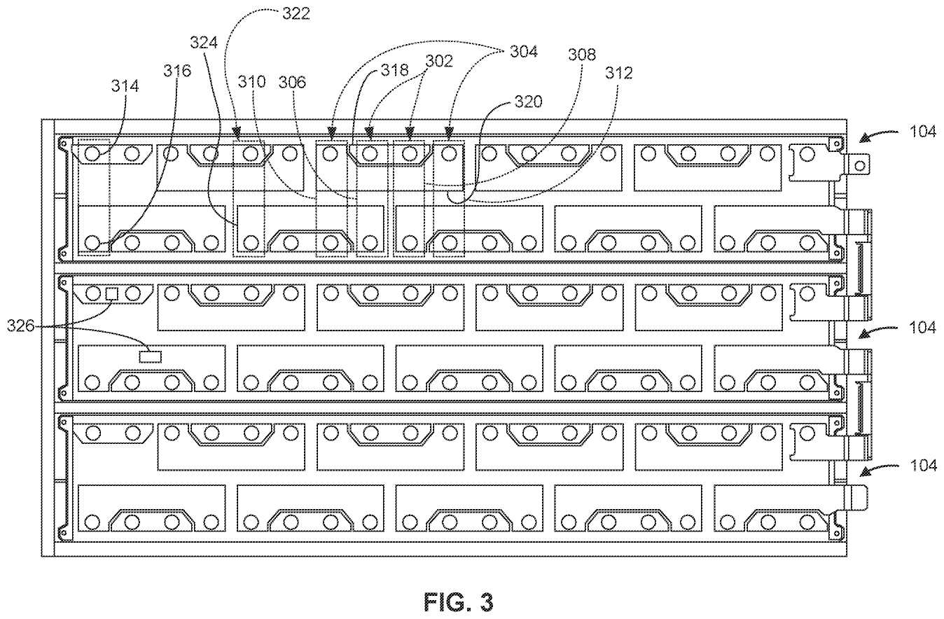

FIG. 3 is a top view of example battery modules 104, each having leaping bus bars and linear bus bars. As shown, each battery module 104 may include multiple battery cells 306, 308, 310, 312, and 322 (e.g., corresponding to battery cells 106 described herein), including a pair of adjacent battery cells 302 and a pair of non-adjacent battery cells 304. The pair of adjacent battery cells 302 may include a first battery cell 306 and a second battery cell 308. The pair of non-adjacent battery cells 304 may include a third battery cell 310 and a fourth battery cell 312. The first battery cell 306, the second battery cell 308, the third battery cell 310, and the fourth battery cell 312 may each include a first terminal 314 and a second terminal 316. The first terminals 314 may have the same polarity (e.g., positive) and the second terminals 316 may have the same polarity (e.g., negative). Accordingly, the first terminals 314 may be positive terminals and the second terminals 316 may be negative terminals. In some implementations, a battery module 104 may employ a polarity configuration reversed to that described herein (e.g., the first terminals 314 may be negative terminals and the second terminals 316 may be positive terminals).

Alternatively, adjacent battery cells may be arranged so that adjacent terminals have opposite polarities. By doing so, sets of linear bus bars and leaping bus bars may connect battery cells in series with one another. For example, the battery cells 306, 308 may be arranged such that the first terminal 314 of the first battery cell 306 may have a different polarity than the first terminal 314 of the second battery cell 308. Likewise, the second terminal 316 of the first battery cell 306 may have a different polarity than the second terminal 316 of the second battery cell 308. For example, the first terminal 314 of the first battery cell 306 may be a positive terminal and the first terminal 314 of the second battery cell 308 may be a negative terminal. The second terminal 316 of the first battery cell 306 may be a negative terminal and the second terminal 316 of the second battery cell 308 may be a positive terminal. When connected by the linear bus bar 318, the first battery cell 306 and the second battery cell 308 may be connected in series with one another. The first battery cell 306 and the second battery cell 308 may be connected in series with additional battery cells via additional leaping bus bars and/or linear bus bars.

A first linear bus bar 318 may electrically connect a first terminal 314 of the first battery cell 306 to a first terminal 314 of the second battery cell 308. The first terminals 314 of the first battery cell 306 and of the second battery cell 308 may have the same polarity or a different polarity, as discussed above. A first leaping bus bar 320 may electrically connect the first terminal 314 of the third battery cell 310 to the first terminal 314 of a fourth battery cell 312. The first terminals 314 of the third battery cell 310 and of the fourth battery cell 312 may have the same polarity (i.e., both are either positive or negative) or a different polarity, as discussed above. Further, the first linear bus bar 318 may be nested within the first leaping bus bar 320 to form a bus bar set. The second terminal 316 of the first battery cell 306 may be electrically connected to the second terminal 316 of a fifth battery cell 322 via a second leaping bus bar 324. The second terminal 316 of the first battery cell 306 and the second terminal 316 of the fifth battery cell 322 may have the same polarity (i.e., both are either positive or negative) or a different polarity, as discussed above. A different combination of linear bus bars and/or leaping bus bars may connect to the second terminals 316 of the first battery cell 306, the second battery cell 308, the third battery cell 310, and the fourth battery cell 312.

Further, for each battery cell, one terminal may be electrically connected to a leaping bus bar and the other terminal may be electrically connected to a linear bus bar in a different bus bar set (e.g., a linear bus bar that is not nested within the leaping bus bar). For example, if the second terminal 316 of the first battery cell 306 is electrically connected to the leaping bus bar 324, the first terminal 314 of the first battery cell 306 may be electrically connected to the first terminal 314 of the adjacent battery cell 308 via the linear bus bar 318. Likewise, if the first terminal 314 of the first battery cell 306 is electrically connected to the linear bus bar 318, the second terminal 316 of the first battery cell 306 may be electrically connected to the second terminal 316 of a non-adjacent battery cell 322 via the leaping bus bar 324. In other words, a leaping bus bar and a linear bus bar in different bus bar sets may be electrically connected to different terminals of the same battery cell. In this way, the leaping bus bars and the linear bus bars may electrically connect the battery cells in series (if, e.g., adjacent terminals have the same polarity) or parallel (if, e.g., adjacent terminals have different polarities).

Insulators 326 may be disposed on top of the leaping bus bars, the linear bus bars, or both.

As indicated above, FIG. 3 is provided as an example. Other examples may differ from what is described with regard to FIG. 3.

### INDUSTRIAL APPLICABILITY

The leaping bus bars described herein may be used in any battery module and/or battery pack used to power a machine. For example, the leaping bus bars may be used in a battery module and/or battery pack used to power an electric motor of an electric vehicle or an electric work machine. Electric vehicles and electric work machines generally have large battery packs that are difficult to service. For example, a battery module of an electric vehicle or an electric work machine may have an odd number of battery cells that results in terminals for the battery module being located at opposite ends of the battery module. The combination of leaping bus bars and linear bus bars described herein may be used to electrically connect an odd number of battery cells. Moreover, the combination of leaping bus bars and linear bus bars allows for the terminals of the battery module to be located on the same end of the battery module, which may make it easier to service the battery pack, especially in situations where the battery pack is very heavy and/or one or more ends of the battery pack are inaccessible.

What is claimed is:

1. A battery module, comprising:
a battery stack with a plurality of battery cells;
a leaping bus bar electrically connecting multiple non-adjacent battery cells of the plurality of battery cells; and
a linear bus bar electrically connecting multiple adjacent battery cells of the plurality of battery cells, the multiple adjacent battery cells being disposed between the multiple non-adjacent battery cells electrically connected by the leaping bus bar.

2. The battery module of claim 1, wherein the leaping bus bar includes a plate having a flat edge opposite a cutout edge.

3. The battery module of claim 2, wherein the cutout edge is contoured according to a peripheral shape of the linear bus bar.

4. The battery module of claim 1, further comprising multiple terminal bus bars electrically connected to at least one of the plurality of battery cells in the battery stack, the multiple terminal bus bars extending from a same end of the battery stack.

5. The battery module of claim 1, further comprising an insulator disposed on one or more of the leaping bus bar or the linear bus bar.

6. The battery module of claim 1, wherein the battery stack includes an odd number of the plurality of battery cells.

7. A machine, comprising:
an electric motor; and
a battery module electrically connected to the electric motor, the battery module including:
a battery stack with a plurality of battery cells,
a leaping bus bar electrically connecting multiple non-adjacent battery cells of the battery stack, and
a linear bus bar electrically connecting multiple adjacent battery cells of the battery stack,
the multiple adjacent battery cells being disposed between the multiple non-adjacent battery cells electrically connected by the leaping bus bar, and
the linear bus bar being nested within a cutout edge of the leaping bus bar.

8. The machine of claim 7, wherein the leaping bus bar is formed from a plate having a flat edge opposite the cutout edge, and
wherein the cutout edge has a U-shaped configuration.

9. The machine of claim 7, further comprising multiple terminal bus bars electrically connected to at least one of the plurality of battery cells in the battery stack, the multiple terminal bus bars extending from a same end of the battery stack.

10. The machine of claim 7, wherein a first electrical resistance associated with the leaping bus bar is equal to a second electrical resistance associated with the linear bus bar.

11. The machine of claim 7, wherein the leaping bus bar is a first leaping bus bar and the linear bus bar is a first linear bus bar, and
wherein the machine further comprises:
a second leaping bus bar; and
a second linear bus bar,
wherein the first leaping bus bar, the first linear bus bar, the second leaping bus bar, and the second linear bus bar are arranged to electrically connect to the plurality of battery cells in series.

12. The machine of claim 11, wherein the first leaping bus bar is electrically connected to a negative terminal of a battery cell, of the plurality of battery cells, and the second linear bus bar is electrically connected to a positive terminal of the battery cell.

13. The machine of claim 12, wherein the first linear bus bar is electrically connected to a negative terminal of an additional battery cell, of the plurality of battery cells, and the second leaping bus bar is electrically connected to a positive terminal of the additional battery cell.

14. A battery pack, comprising:
a first battery module; and
a second battery module electrically connected to the first battery module, both the first battery module and the second battery module having terminals on a same end of the battery pack, and the first battery module and the second battery module each including:
a battery stack with a plurality of battery cells,
a leaping bus bar electrically connecting multiple non-adjacent battery cells of the plurality of battery cells, and
a linear bus bar electrically connecting multiple adjacent battery cells of the plurality of battery cells, the multiple adjacent battery cells being disposed between the multiple non-adjacent battery cells electrically connected by the leaping bus bar.

15. The battery pack of claim 14, wherein the leaping bus bar is formed from a plate having a flat edge opposite a cutout edge, the cutout edge being contoured according to a peripheral shape of the linear bus bar.

16. The battery pack of claim 14, wherein a first electrical resistance associated with the leaping bus bar is equal to a second electrical resistance associated with the linear bus bar.

17. The battery pack of claim 14, wherein the leaping bus bar is electrically connected to a first terminal of a first battery cell in the multiple non-adjacent battery cells and to a second terminal of a second battery cell in the multiple non-adjacent battery cells, and
wherein the first terminal and the second terminal have a same polarity.

18. The battery pack of claim 14, wherein the linear bus bar is electrically connected to a first terminal of a first battery cell in the multiple adjacent battery cells and to a second terminal of a second battery cell in the multiple adjacent battery cells, and
wherein the first terminal and the second terminal have an opposite polarity.

19. The battery pack of claim 14, wherein the leaping bus bar is a first leaping bus bar and the linear bus bar is a first linear bus bar, and
wherein the battery pack further comprises:
a second leaping bus bar; and
a second linear bus bar,
wherein the first leaping bus bar and the second linear bus bar are electrically connected to different terminals of a first battery cell of the plurality of battery cells, and
wherein the first linear bus bar and the second leaping bus bar are electrically connected to different terminals of a second battery cell of the plurality of battery cells.
